(19) United States
(12) Patent Application Publication
(10) Pub. No.: US 2011/0218690 A1
(43) Pub. Date: Sep. 8, 2011

(54) SYSTEM AND METHOD FOR PROVIDING AUTOMATED ELECTRICAL ENERGY DEMAND MANAGEMENT

(75) Inventors: Cornelius O'Callaghan, Belgooly (IE); Alfred Calvin Rogers, Carolina Beach, NC (US); Dara Patrick O'Neill, Brittas Bay (IE); Patrick James Ballantine, Wilmington, NC (US); Paul Eugene Bowen, Belgooly (IE); Artur Henryk Cirocki, Wilton (IE)

(73) Assignee: Efficient Energy America Incorporated, Carolina Beach, NC (US)

(21) Appl. No.: 13/041,212

(22) Filed: Mar. 4, 2011

Related U.S. Application Data
(60) Provisional application No. 61/310,788, filed on Mar. 5, 2010.

(51) Int. Cl. G06F 1/32

(52) U.S. Cl. 700/295

(57) ABSTRACT

A system and method for providing energy demand management. The system and method may comprise at least one network element communicatively coupled to at least one equipment, wherein the at least one equipment consumes energy or generates energy. The system and method may also comprise a master control unit communicatively coupled to the at least one network element, wherein the master control unit is configured to monitor and manage energy use at the at least one equipment via the at least one network element. The system and method may also comprise a server communicatively coupled to the master control unit over a network, wherein the server is configured to process a variety of information useful for the master control unit.

### CROSS-REFERENCE TO RELATED APPLICATIONS

The patent application claims priority to U.S. Provisional Patent Application No. 61/310,788, entitled “System and Method for Providing Energy Management,” filed on Mar. 5, 2010, which is incorporated by reference in its entirety.

### FIELD OF THE DISCLOSURE

The present invention relates generally to providing energy management, and more specifically, to a system and method for comprehensively and efficiently managing peak electrical energy demand using automated, predictive, and self-refining control systems.

### BACKGROUND INFORMATION

Peak demand, in terms of energy use, describes a period of strong consumer demand for energy consumption. Peak demand, peak load, or on-peak are terms used interchangeably to describe a period of time in which electrical power is expected to be provided for a sustained period of time at a significantly higher than average supply level. Peak demand fluctuations typically occur on daily, monthly, seasonal, and/or yearly cycles. For an electric utility company or provider, peak demand may represent a high point or peak of customer consumption of electricity or other resource. An actual point of peak demand may be a single half-hour or hourly period.

For decades, utility companies and providers have sold off-peak power and energy to consumers at lower rates as a way to encourage users to shift loads to off-peak hours, similar to the way telephone companies and providers incentivize their individual customers. Concurrently, consumers are charged with high premiums for significant energy demand and consumption during on-peak periods. These costs and charges unnecessarily result in a penalizing effect for consumers and users, even for those who implement traditional energy management techniques.

As a result, a system and method for providing a comprehensive, efficient, and cost-effective way for energy demand management may be highly desirable.

A large proportion of energy consumption in buildings is generally attributable to heating and cooling systems. Heating and cooling systems typically use control methods that use target temperature set-points only. However, temperature set-points are not the best way to control heating and cooling systems for spaces that are occupied by people because various factors other than temperature affect human thermal comfort while in those spaces.

According to ANSI/ASHRAE (American National Standards Institute/American Society of Heating, Refrigeration, and Air-Conditioning Engineers) standards, human thermal comfort is defined as the state of mind that expresses satisfaction with the surrounding environment.

Typically, systems switch the heating or cooling mechanism on and off using hysteresis values and dead-bands around a target temperature set-point. These control methods may lead to regulation of temperature that do not directly address thermal comfort. As a result, this may lead to the use of excessive energy trying to regulate temperature only than that which would be required if the system regulated based on human thermal comfort. By regulating heating and cooling based on some or all of the factors that contribute to human thermal comfort may not only lead to optimized comfort for people but also increased energy reduction for any given space.

Thus, a system and method for providing a comprehensive, efficient, and cost-effective techniques for controlling heating and cooling directed to human thermal comfort targets may also be highly desirable.

### BRIEF DESCRIPTION OF THE DRAWINGS

In order to facilitate a fuller understanding of the exemplary embodiments, drawings have been appended. These drawings should not be construed as limiting, but are intended to be exemplary only.

FIG. 1 depicts an illustrative energy bill, according to an exemplary embodiment of the invention.

FIG. 2 depicts an illustrative block diagram of a system architecture for providing energy management, according to an exemplary embodiment of the invention.

FIG. 3 depicts an illustrative hardware component for providing energy management, according to an exemplary embodiment of the invention.

FIG. 4 depicts an illustrative hardware component for providing energy management, according to an exemplary embodiment of the invention.

FIG. 5 depicts an illustrative flowchart for providing energy management, according to an exemplary embodiment of the invention.

FIG. 6 depicts an illustrative flowchart for providing energy management, according to an exemplary embodiment of the invention.

FIG. 7 depicts an illustrative flow for providing energy management, according to an exemplary embodiment of the invention.

FIG. 8A-8D depict illustrative screens for providing energy information to a user, according to an exemplary embodiment of the invention.

FIG. 9 depicts an illustrative flowchart for providing automated energy demand management at a site, according to an exemplary embodiment of the invention.

FIG. 10 depicts an illustrative flowchart for reducing energy consumption at a site, according to an exemplary embodiment of the invention.

FIG. 11 depicts an illustrative flowchart for determining control values for reducing energy consumption at a site, according to an exemplary embodiment of the invention.

### DETAILED DESCRIPTION OF EMBODIMENTS

Various exemplary embodiments may be directed to a system and method for providing energy management, and more specifically, to a system and method for comprehensively and efficiently managing peak electrical energy demand using automated, predictive, and self-refining control systems. It should be appreciated that the following summary and descriptions are exemplary and explanatory only and are not restrictive.

As described above, utility companies and providers charge consumers and users high premiums for significant energy demand and consumption during on-peak periods. As a result, improved energy demand management may be required to reduce these penalizing costs and charges.

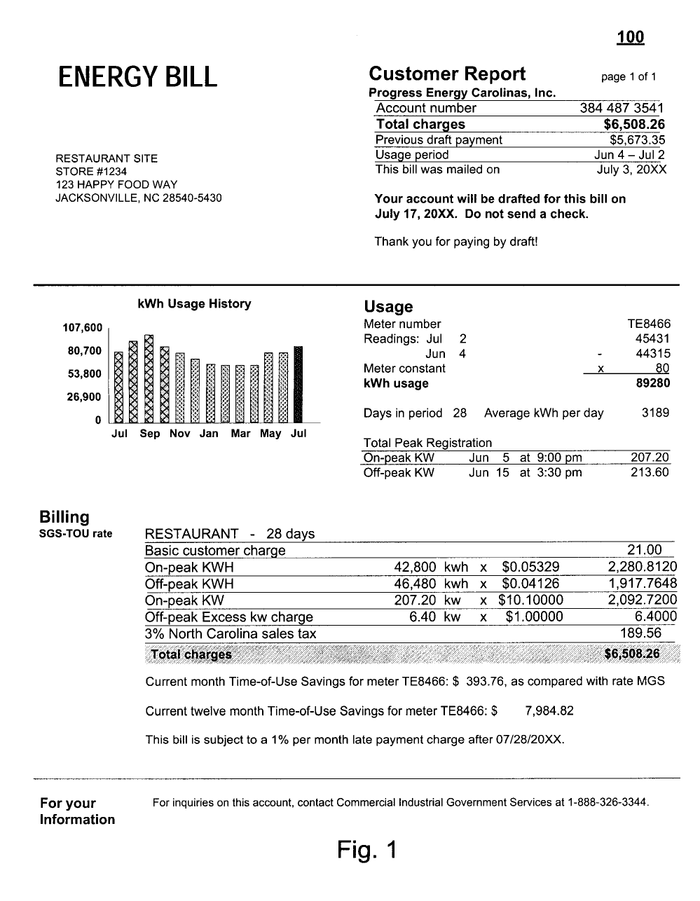

For example, FIG. 1 depicts an illustrative energy bill 100. The energy bill 100 may be received by a small business to illustrate its use of energy over a period of time. In this example, total energy consumption, costs, etc. may be shown. Peak energy demand and corresponding costs may also be illustrated in the energy bill 100.

For example, the energy bill 100 shown may depict a billing of kilowatt-hours (KWH), which may be a standard electrical consumption measurement of power over time. The KWH may be charged at different rates depending on whether energy is consumed during on-peak or off-peak hours (which may typically be day or night, respectively). This energy bill 100 may depict an on-peak consumption of 42,800 KWH and an off-peak consumption of 46,480 KWH, which may equate, in dollar terms, to approximately $2,280 and $1,917, respectively. The demand measurement may be established by taking a continuous reading of an electrical requirement of the building or site. It should be appreciated that this demand measurement may not be a measure of consumption, but rather a measure of how much electrical power may be required at any given time. Accordingly, the utility provider may charge for such demand measurement at the highest rate that occurs during a month (e.g., readings of average requirement may be registered every 15 minutes or other predetermined amount of time and the highest registered requirement is billed). As shown in the energy bill 100, the amount charged for electricity that is actually consumed may be at a rate that roughly equates to 66% of the total bill. The other 33% of the energy bill 100 may not be for electricity that is consumed, but rather, for the maximum amount of demand that was required during the month. In this energy bill 100, the highest average demand may be 207 KW, which equates to $2092 in dollar terms for which the utility provider must charge its client. In other words, a utility provider may charge a consumer this charge simply for making sure they allot the capacity to hand such a demand for power even though such demand in power is not actually ever required or consumed.

Generally, in a building where there is little or no control over how or when heavy electrical loads start and stop, it may be appreciated that loads may start randomly and without structure or governance. In this case, it is very likely that coincidental starting and running of such heavy loads may lead to demands that are higher than would be found if the loads were managed and started sequentially in a governed and structured fashion. Thus, a system to ensure sophisticated and regulated control over such heavy loads so that while each load is allowed its required run time the likelihood of coincidental running of loads is reduced may be desired. This in turn reduces the likelihood of higher demand charges.

Energy demand management may entail actions that influence the quantity and/or patterns of energy use by end users or consumers. Such actions generally include targeting a reduction of peak demand during periods when energy-supply systems are constrained. It should be appreciated that peak demand management does not necessarily decrease total energy consumption but may provide a way to load-balance energy consumption with available energy resources and to reduce the need for investments in or expected use of one or more energy resources (e.g., networks, power plants, etc.). A way to deal with varying electrical loads may be to simply decrease the difference between generation and demand. If energy demand management is achieved by changing loads, such load changes may be referred to as demand side management (“DSM”).

In residential and small business applications, for example, appliance control modules may be used to reduce energy usage of water heaters, air conditioning units, refrigerators, and/or other devices by turning them off for some portion during peak demand time and/or by reducing power drawn by these devices. In some embodiments, energy demand management may include more than just reducing overall energy use or shifting loads to off-peak hours. For example, more energy-efficient equipment may be installed and used. Efficient energy use, or energy efficiency, may describe using less energy to provide the same level of energy service. For instance, insulating a home may allow a building to use less heating and cooling energy to achieve and maintain a comfortable temperature. Another example may be installing fluorescent lights or skylights instead of incandescent lights to attain the same level of illumination. Many utility companies and providers may also give rebates or other incentives for users or consumers that purchase and use energy-efficient equipment, such as energy-efficient insulation, weather-stripping, appliances, light bulbs, etc. Efficient energy use may therefore be achieved primarily by implementing more efficient technologies and/or processes rather than by actually changing in individual behavior. These and other energy efficient use techniques may help to reduce undesirable peak demand costs.

Embodiments of the present invention may provide a system and method for comprehensively, efficiently, and cost-effectively managing peak energy demand using automated, predictive, and self-refining control systems. Embodiments of the present invention may also provide a system and method for comprehensively and efficiently reducing energy consumption using automated, predictive, and self-refining control systems

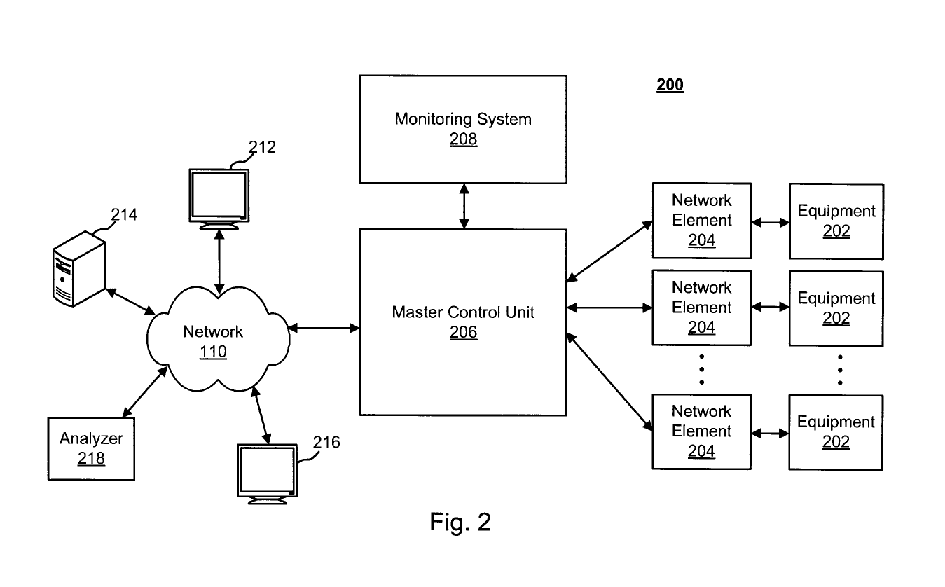

FIG. 2 depicts an illustrative block diagram of a system architecture for providing energy management 200, according to an exemplary embodiment of the invention. As illustrated, one or more equipment 202 may be communicatively coupled with one or more network elements 204, which in turn may be communicatively coupled to a master control unit 206. A monitoring system 208 may be communicatively coupled to the master control unit 206. The master control unit 206, via network 210, may also be communicatively coupled to a control station 212, a web server 214, a remote monitoring station 216, an analyzer 218, and/or other device.

System 200 may be primarily used for efficiently managing electrical energy demand at one or more sites. System 200 may also have other implementations as well, such as other forms of power and energy (e.g., solar, wind, nuclear, etc.) or non-power/energy related enterprises (e.g., business, facilities management, etc.). System 200 may also be used in a micro- or macro-level in association with private, commercial, government, and/or non-profit organizations.

The various components of system 200 as shown in FIG. 2 may be further duplicated, combined, and/or integrated to support various applications and platforms. Additional elements may also be implemented in the systems described above and below to support various applications.

Equipment 202 may be any equipment that consumes energy and/or generates energy. These may include a thermostat, air conditioning unit, HVAC, lighting, water heater, motorized equipment and/or other appliance, system, or unit.

Network element 204 may be any input/output (“I/O”) device for facilitating communication between the equipment 202 and the master control unit 206. For example, in one embodiment, the network element 204 may be a remote, wireless I/O device communicatively coupled to equipment, such as an A/C unit. Network element 204 may be a multifunctional device having a plurality of digital/analog inputs and/or outputs. Network element 204 may also include one or more communications links, such as RS232/RS485. Other various types of input, output, and communication links may also be provided.

In some embodiments, the network element 204 may be communicatively coupled to one or more sensors. These may include sensors that are configured to accurately and reliably monitor, determine, receive, and transmit data associated with temperature, humidity, amount of light, etc. The one or more sensors may be compact in size, battery-powered, easily installed, or a combination thereof. The one or more sensors may also be fully-integrated or partially-integrated with, or entirely distinct and separate from the network element 204. In some embodiments, the one or more sensors may be communicatively coupled to the master control unit 206. The one or more sensors may include, but are not limited to, a temperature sensor, power failure detector, humidity sensor, motion detector, or other similar sensor.

In some embodiments, the network element 204 may be distinct and separate from the equipment 202. In other embodiments, the network element 204 may be partially or fully integrated with the equipment 202. It should be appreciated that while each equipment 202 is depicted as corresponding to a single network element 204 in system 200 of FIG. 2, a variety of embodiments may be provided. For example a plurality of network elements 204 may be communicatively coupled to a single piece of equipment 202, or a plurality of equipment 202 may be communicatively coupled to a single network element 204. In these examples, one network element 204 may receive and transmit information to a plurality of equipment 202 or each of plurality of network elements 204 may receive and transmit information to a portion of a singular piece of equipment having many parts 202.

Network element 204 may transmit and receive data to and from the equipment 202 and the master control unit 206. The data may represent a variety of communications data, such as control data, monitoring data, energy consumption data, etc. The data may be transmitted and/or received utilizing a variety of standard telecommunications protocols or a standard networking protocols. For example, one embodiment may utilize Session Initiation Protocol (“SIP”). In other embodiments, the data may be transmitted or received utilizing other Voice Over IP (“VOIP”) or messaging protocols. For example, data may also be transmitted or received using Wireless Application Protocol (“WAP”), Multimedia Messaging Service (“MMS”), Enhanced Messaging Service (“EMS”), Short Message Service (“SMS”), Global System for Mobile Communications (“GSM”) based systems, Code Division Multiple Access (“CDMA”) based systems, Transmission Control Protocol/Internet (“TCP/IP”) Protocols, or other protocols and systems suitable for transmitting and receiving data. Data may be transmitted and received wirelessly or may utilize cabled network or telecom connections such as an Ethernet RJ45/Category 5 Ethernet connection, a fiber connection, a traditional phone wireline connection, a cable connection or other wired network connection. Network 204 may use standard wireless protocols including IEEE 802.11a, 802.11b and 802.11g. Other communications interfaces may also be used, such as RS485, RS232, XBEE radio, Zigbee, 802.15.4, low-rate wireless personal area network (LR-WPAN), or other communication interfaces. Network 204 may also use protocols for a wired connection, such as an IEEE Ethernet 802.3. Other various embodiments may also be provided.

Master control unit 206 may be a central processing unit for operating and managing the system 200. The master control unit 206 may include one or more programmable logic controllers, a number of communication interfaces, and a variety of equipment interfaces. The master control unit 206 may also include one or more data storage devices for storing data.

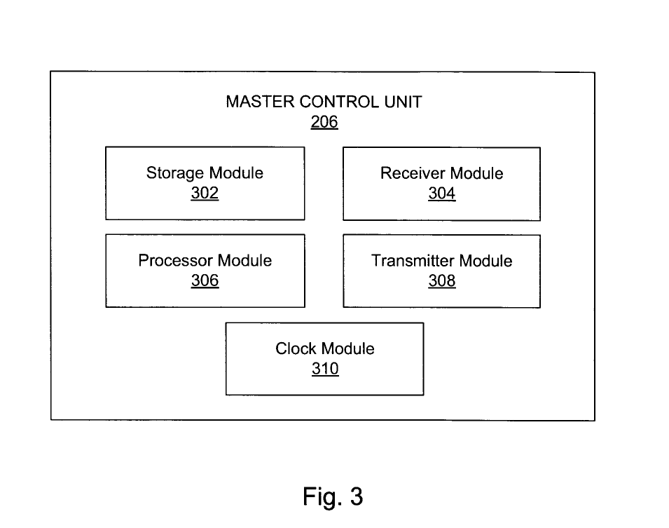

FIG. 3 depicts an illustrative hardware component for providing energy management, according to an exemplary embodiment of the invention. Referring to FIG. 3, the master control unit 206 may include a storage module 302, a receiver module 304, a processor module 306, a transmitter module 308, and a clock module 310, all of which may be communicatively coupled to one another within the master control unit 206 and with a variety of other devices and system external to the master control unit 206, such as the network element 204, the monitoring system 208, or other devices, network components, and systems, via network 210.

The receiver module 304 and transmitter module 308 may be configured to communicate data to and from the master control unit 206. For example, the various communication methods and protocols used for the network element 204, as described above, may also be used by the receiver module 304 and the transmitter module 308.

The processor module 306 may include programmable control logic for providing efficient energy management. The processor module 306 may be customized for various installations for controlling energy use at one or more sites. In some embodiments, the processor module 306 may include programmable control logic that may be identified in four (4) functional groups: (i) load control, (ii) load communications, and (iii) system communications and data-logging, and (iv) self-refining control, (ii).

The function and operation of the processor module 306 of the master control unit will become apparent as each of these functional groupings are discussed in an exemplary embodiment below.

One of the primary functions of the master control unit 206 may be to manage peak demand (e.g., kilowatt (kW) demand) of a particular site (e.g., a building) to as low a level as possible without significantly affecting the overall environment of that site. Peak demand may be understood as a measure of the maximum amount of electrical power in use at a site at any given time. As described above, utility companies or providers may charge premiums based on the maximum peak energy that is used during a given time period (e.g., a month). In general, a utility meter or other device may read the peak constantly and the highest average of peak energy usage, for example, in any predetermined time period (e.g., 15 minutes) within that month may be recorded as the maximum peak demand. Accordingly, a consumer or user at the site may be charged to pay one or more charges and rates for an entire billing cycle based on this maximum value.

In most small to medium sized commercial facilities, there may be little or no control over how power or energy (e.g., electrical) loads start and stop. It may be even harder for high usage systems and appliances, such as air conditioning units or refrigeration units. Coincidental starting and stopping of these units in an unmanaged or random fashion may often lead to even higher than necessary maximum peak demand, even though the idea is to conserve energy use. Accordingly various embodiments of the present invention, the master control unit 206 may take control of these energy-consuming units or equipment 202 in order to optimize energy use and to minimize peak demand. Rather that implementing a coincidental starting/stopping of various units at a site, the master control unit 206 may provide an orderly way to start and stop units 202 while monitoring the conditions of the site environment to ensure that conditions at the site remain relatively unaltered. In other words, the master control unit 206, using its various modules, may receive, transmit, measure, and/or analyze data related to a site's environment in a complex feedback system to comprehensively and effectively manage peak energy demand. The master control unit 206 may efficiently manage and load-balance available energy resources so that any coincidental peak demand may be greatly reduced or eliminated.

As discussed above, the master control unit 206 may be communicatively coupled to one or more network elements 204. Each network element 204 may be fitted for equipment 202 that will be managed by the master control unit 206. The equipment 202 may generally be high electrical load equipment, although other types of equipment may also be compatible.

The master control unit 206 may initially set up one or more targets and operation times and tolerances. The master control unit 206 may also scan input requests for power from each network element to determine whether or not to supply power to the equipment 202. In some embodiments, the master control unit 206 may have a 50 ms scan time. Other various scan times may also be implemented.

Accordingly, the master control unit 206 may constantly receive data, via the receiver module 304, from the one or more network elements 204. The master control unit 206 may also process, via the processor module 306, and write to one or more data storage units at the one or more network elements 204. In some embodiments, serial data transmission may be implemented. Transfer of information and data between the master control unit 206 and the one or more network elements 204 may also be no more than two memory words in length, e.g., 16 bits. As a result, communications may be achieved relatively quickly. For instance, the master control unit 206 may read a first word from internal memory of the network element 204 and store it in space allocated to that specific network element 204. The master control unit 206 may then write the second word to the network element 204 from another allocated space in memory of the network element 204.

The read word may take input data from the one or more network elements 204 and transfer it to the master control unit 206. It should be appreciated that data may be a digital signal (e.g., an on/off signal for a thermostat or other similar device), an analog signal (e.g., current speed of a motorized unit or other similar appliance component), or serial information (e.g., instructions from a computing device).

The write word may take instructions from a load control matrix and write them to one or more outputs of the one or more network elements 204. It should be appreciated that the one or more outputs may be a digital signal (e.g., on/off switch or relay signal), an analog signal (e.g., set speed of a motor), or serial information (e.g., instructions from a computing device).

The load control matrix may be a cluster of simple functions that operate together with information about the value of load at each network element 204, current consumption data, and predefined targets and tolerances as set by the processor module 306, or more specifically, a self-refining control component of the processor module 306. Depending on the results and functions, additional information may be transmitted to the load communications sections.

The load communications section of the processor module 306 may forward read data and write data to one or more network elements 204 in a structured and processor-efficient manner. Other various embodiments may also be provided.

As the one or more equipment 202 requests power through corresponding one or more network elements 204, the requests may be filtered through the load control matrix. As discussed above, the load control matrix may monitor current demand level and current maximum allowable demand target, and may decide which of the equipment 202 may run and in a sequence for their efficient operation so that current demand does not exceed the target maximum demand.

Once the request for power has been processed through the load control matrix, the request may be granted immediately or delayed until other units have been adjusted to allocate “space” (or time) so that demand target may be achieved.

The self-refining control feature of the processor module 306 may provide an important feature for the master control unit 206. In some embodiments, a self-refining control algorithm (“SRCA”) may function to assess current demand and/or create one or more target values for the load control matrix. The SRCA may operate to continuously reduce demand target since the SRCA may continuously monitor current demand and current target it has set. Other various embodiments may also be provided.

The SRCA may monitor rate of requests from the one or more network elements 204 and assess impact on current levels of demand reduction on the site. In the event impact is within a predetermined tolerance, the SRCA may reduce its target for a specific period of time and later reassess conditions. However, in the event impact is outside and not within predefined tolerance, the SRCA may increase its target for a specific period of time and then reassess the situation. In either situation, the SRCA may have the ability to take outside factors into consideration and to shift the tolerances within which it operates in order to optimize and balance load. Some examples of these outside factors that may shift tolerances may include: outside temperature, humidity, site- or building-specific schedule modules, demand response requests from power and utility companies, etc.

In summary, the SRCA may play an important role in overall demand reduction. The SRCA may set a target for maximum peak demand (e.g., kW demand) for a particular site or building. The SRCA may initially begin with a peak demand from the same month as last year reduced by a certain target percentage (e.g., 30%). The SRCA may then set this new value as its target demand and begin searching for an appropriate demand target.

The SRCA may determine the appropriate level for demand target at any given time based on continuous analysis and assessment of requests for power from each of the one or more network elements 204. The rate of requests may be compared with performance of each equipment 202 when power is supplied. If the network element 204 fails to have its request for power satisfied by the power served by the master control unit 206, a comparison may be made between a time period that the request for power was made and a time period when the master control unit 206 granted power. Thus, if the difference between the two time periods is above a certain predetermined tolerance level, the SRCA may be forced to take action.

For example, one action the SRCA may take is prioritization. In this example, the SRCA may balance amount of time each network element 204 gets power so that corresponding equipment 202 may perform at optimal levels. It should be appreciated that this may take place before the SRCA changes its demand target. This step may therefore be achieved by prioritizing the equipment 202 based on a ratio that is derived from a percentage (%) hit rate that each piece of equipment has when it requests power and compared with power that is served.

Here, equipment whose requirement is always satisfied by power served may be given a highest priority rating (e.g., priority 5) and equipment whose requirement is never satisfied may be given a lowest priority rating (e.g., priority 1). The load control matrix may then take these priority ratings into account when determining which equipment is to be served with power so the priority-1 equipment now gets power for longer and the priority-5 equipment gets power for less time.

If balance of load through such priority assignment does not repair the problem and the an average request/service percentage is still outside of tolerance, then the SRCA may move demand target up by 5% and a process of analysis recommences. Conversely, if the balance of load values leaves all equipment within tolerance, the SRCA may reduce the demand target accordingly and the process of analysis recommences. Thus, the method of reassessment or “self-refining” may continue.

The clock module 310 may include a timing device. For example, timing device may be a real time clock having one or more battery back-ups. In some embodiments, the timing device may be updated with atomic clock data (e.g., from a NIST time server). The function and features of the clock module 310 may be important in monitoring and trending peak demand values at the master control unit 206.

It should be appreciated that the master control unit 206 may be positioned on-site, e.g., in a building or other structure where energy consumption is to be managed. However, other various embodiments may also be provided, such as the master control unit 206 being positioned at an off-site location or in one or more other configurations.

The monitoring system 208 may be used for monitoring and/or trending energy consumption at the site. The monitoring system 208 may be communicatively coupled to the master control unit 206 and one or more network elements 204 in order to assess energy consumption at one or more equipment 202 and to allow the master control unit 204 and the one or more elements 204 to make operational changes and adjustments around such assessments. In effect, the monitoring system 208 may provide information to one or more users with information about how well the system 200 is performing and optimizing energy use.

The monitoring system 208 may include a panel for mounting at a main electrical entry point of a particular site. The panel may take specific electrical consumption readings and may send these readings to the master control unit 206. In some embodiments, these readings may also be sent to one or more data storage units (not shown). For example, if these readings are stored in one or more data storage units, one or more web servers may be able to access this information as well for additional operation and/or monitoring functions.

It should be appreciated that monitor information may be stored within a network database (e.g., an Internet-enabled SQL database). The database may be located client-side and/or on-site. Various encryption and security features (e.g., username and password) may be provided to secure the information.

Part of the monitoring system 208 may include a graphical user interface from which a customer may change schedule times and/or shift an impact target of the master control unit 206, especially in the event the customer desires to manually adjust (or experiment) with the system 200 for achieving optimal results in demand reduction.

Network 210 may be a wireless network, a wired network or any combination of wireless network and wired network. For example, network 210 may include one or more of a fiber optics network, a passive optical network, a cable network, an Internet network, a satellite network (e.g., operating in Band C, Band Ku or Band Ka), a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.1, 802.11n and 802.11g or any other wired or wireless network for transmitting or receiving a data signal. In addition, network 202 may include, without limitation, telephone line, fiber optics, IEEE Ethernet 802.3, a wide area network (“WAN”), a local area network (“LAN”), or a global network such as the Internet. Also, network 210 may support, an Internet network, a wireless communication network, a cellular network, or the like, or any combination thereof. Network 202 may further include one, or any number of the exemplary types of networks mentioned above operating as a stand-alone network or in cooperation with each other. Network 202 may utilize one or more protocols of one or more network elements to which it is communicatively coupled. Network 210 may translate to or from other protocols to one or more protocols of network devices. Although network 210 is depicted as one network, it should be appreciated that according to one or more embodiments, network 210 may comprise a plurality of interconnected networks, such as, for example, the Internet, corporate networks, and/or home networks. Other various embodiments may also be provided.

Control station 212 and remote monitoring system 216 may provide support and additional monitoring features of system 200. In some embodiments, the control station 212 and remote monitoring system 216 may typically be remote to the master control unit 206. In some embodiments, the master control unit 206 may have an allocated area of memory where data regarding the systems operational status, statistics about consumption, performance, and certain alarm trigger conditions may be stored. This data, for example, may be routinely polled by server 214 (or other system component) and added to memory. The system 200 may then be available to be used by a web interface (e.g., remote monitoring station 216) for display in one or more formats (e.g., tables, charts, graphs, etc.). In a similar manner, the master control unit 206 may allocate an area of memory for receiving data from the control station 212. The master control unit 206 may be pre-programmed to integrate and utilize this received data into the system 200. Values in the data may be changed or adjusted via the control station 212 (or other interface). In some embodiments, this may provide one or more options to set certain conditions of operation through a customized web page. The control station 212 and remote monitoring system 216 may also register and relay reports and alarm statuses to customers. Other various embodiments may also be provided.

Server 214 may be a web server configured to process a variety of information. The server 214 may be communicatively coupled to one or more data storage units. The server 214 may be accessible via network 210 using a variety of terminals, such as the control station 212, remote monitoring system 216, the analyzer, and/or the master control unit 206. In some embodiments, it should be appreciated that the server 214 may include virtualization software, emergency power supply, etc. Data stored by the server 214 may be in a database (e.g., SQL or other similar database format). It should be appreciated that information stored by the server 214 may be numeric over time, date/time-stamped, and/or location-specific. Greater data complexity may come into play when the information is drawn out and shown on the web-interfaces afterwards. Therefore, other various embodiments may also be provided.

Analyzer 218 may provide a sales agent to go a specific site and carry out a survey of electrical load at that particular site. Information on the electrical loads may be received at the analyzer 218. The analyzer 218 may be matched against one or more databases (locally or remotely via the network 210). The analyzer 218 may continually update and transfer the information to and from other components of the system (e.g., the control station 212, server 214, and/or remote monitoring station 216).

In some embodiments, all information gathered at the site of the analyzer 218 may be transferred to server 212. The server 212 may run a series of tests to analyze the information and prepare one or more statements of electrical make-up of the site, which may provide a picture as to how system 200 may be implemented at the site and what energy and financial savings may be achieved for the potential customer. In effect, the analyzer 218 provides an automated tool, analogous to a live engineer consultant, to assist in the sale, design, and implementation of system 200. The analyzer 218 may also generate one or more reports associated with the sale, design, and implementation of an efficient power management solution at the site.

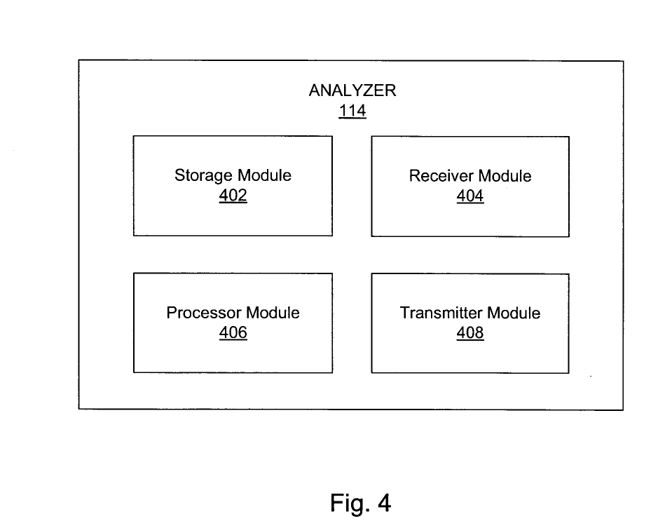

FIG. 4 depicts an illustrative hardware component for providing energy management, according to an exemplary embodiment of the invention. Referring to FIG. 4, the analyzer 218 may include a storage module 302, a receiver module 304, a processor module 306, and a transmitter module 308, all of which may be communicatively coupled to one another within the analyzer and with a variety of other devices and system external to the analyzer 218, such as the server 214, or other devices, network components, etc.

It should be appreciated that the analyzer 218 may be implemented in software, hardware, or a combination thereof. In one embodiment, the analyzer 218 may be developed using Microsoft® Visual Basic and Microsoft® SQL server. However, it should be appreciated that other various programming tools/language and database protocols may also be used.

In general, the analyzer 218 may be used to collect data about individual buildings. Surveyors or field agents may carry out one or more building surveys when visiting a building or site. At each building or site, the surveyor or field agent may check, for example, what heavy electrical loads are present in the building or site. The analyzer 218 may also have a built-in database (or have access to one or more databases) with information related to typical heavy electrical loads. These measured loads at the building or site may be entered through a “New Survey” form, for example, at the analyzer 218. The entries may be time- and/or date-stamped when entered or submitted. Once the new survey form is submitted and sent to the system 200 (e.g., server 214), the system 200 may process the survey data. In some embodiments, the survey information may be processed using pre-defined steps and/or formulas (e.g., a “savings calculation” method, an “implementation” method, or other process). The server 214 may then transmit one or more reports based on the calculation (e.g., a “savings report,” an “implementation report, etc.) to the surveyor or field agent and/or to one or more sales staff for presentation to customers. In some embodiments, these reports may also be directly transmitted to the customer. The server 214 may stored data from these survey for further use, such as in generating or producing additional code/instructions for each installed component, bills of materials, system documentation, system improvement, etc.

It should be appreciated that the monitoring system 208, the control station 212, remote monitoring system 216, and the analyzer 218 may be a desktop computer, a laptop computer, a server, a personal digital assistant, or other computer capable of sending or receiving network signals (e.g., CPE, a television, radio, phone, appliance, etc.). The components of system 200 may use a wired or wireless connection. It should also be appreciated that the components of system 200 may be any of a number of portable electronic device capable of being transported in or out of a unit of the site.

The monitoring system 208, the control station 212, remote monitoring system 216, and the analyzer 218 may include one or more processors for recording, transmitting, receiving, and/or storing data. Although the monitoring system 208, the control station 212, remote monitoring system 216, and the analyzer 218 are depicted as individual elements, it should be appreciated that the contents of one or more of a network element, transceiver 218, and data storage 208 may be combined into fewer or greater numbers of devices and may be connected to additional devices not depicted in FIG. 2. Furthermore, the monitoring system 208, the control station 212, remote monitoring system 216, and the analyzer 218 may be local, remote, or a combination thereof to the master control unit 206.

Data storage (not shown for each component) may be provided at each of the components of the system 200. Data storage may be network-accessible storage and may be local, remote, or a combination thereof to any of the other components of system 200. Data storage may be utilized in a variety of platforms or protocols, such as a redundant array of inexpensive disks (“RAID”), tape, disk, a storage area network (“SAN”), an internet small computer systems interface (“iSCSI”) SAN, a Fibre Channel SAN, a common Internet File System (“CIFS”), network attached storage (“NAS”), a network file system (“NFS”), or other computer accessible storage (e.g., flash, compact, SD-related, etc.). In one or more embodiments, data storage may be a database, such as an Oracle database, a Microsoft® SQL Server database, a DB2 database, a MySQL database, a Sybase database, an object oriented database, a hierarchical database, or other database. Data storage may utilize flat file structures for storage of data.

It should be appreciated that the contents of any of these one or more data storage systems may be combined into fewer or greater numbers of data storage systems and may be stored on one or more data storage systems or servers. Furthermore, the data storage systems may be local, remote, or a combination thereof to clients systems, servers, or other system components. In some embodiment, information stored in the data storage may be useful in providing additional personalizations and customizations. Other various data storage embodiments may also be realized.

It should be appreciated that the components of system 200 may be one or more servers (or server-like devices). Each of the components of system 200 may include one or more processors (not shown for each component) for recording, transmitting, receiving, processing, and/or storing data. According to one or more embodiments, the components of system 200 may be servers providing control and/or monitoring access to the system 200. In other embodiments, the components of system 200 may be servers that provide network connection between one or more wireless devices. The components of system 200 may also be servers of a service provider for providing efficient resource management. Other various embodiments may also be provided.

While depicted as various servers, components, elements, or devices, it should be appreciated that embodiments may be constructed in software or hardware, virtual or physical, as a separate or stand-alone device, as part of an integrated transmission or switching device, or a combination thereof.

Additionally, it should also be appreciated that system support and updating the various components of the system 200 may be easily achieved. For example, a system administrator may have access to one or more of the components of the system, network, components, elements, or devices. It should also be appreciated that the one or more servers, components, elements, or devices of the system may not be limited to physical components. These components may be software-based, virtual, etc. Moreover, the various servers, components, elements, or devices may be customized to perform one or more additional features and functionalities. Such features and functionalities may be provided via deployment, transmitting, or installing software or hardware.

It should be appreciated that the system 200 of FIG. 2 and the hardware components 300 of FIG. 3 and 400 of FIG. 4 may be implemented in a variety of ways. The architectures 200 and components 300 and 400 may be implemented as a hardware component (e.g., as a module) within the system 200. It should also be appreciated that the architectures 200, 300, and 400 may be implemented in computer-executable software or other non-hardware embodiment. Although depicted as a single architecture, module functionality of the architectures 200, 300, and 400 may be located on a single device and/or distributed across a plurality of devices including one or more centralized servers and one or more pieces of customer premises equipment or end user devices.

By providing an efficient power management system, peak energy demand and associated costs, charges, and penalties may be reduced or eliminated. Thus, a robust and comprehensive system for power and energy management may be provided.

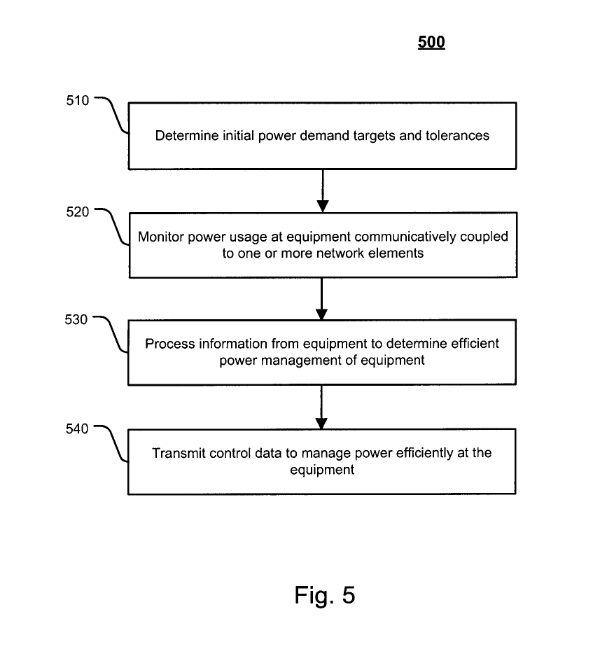

FIG. 5 depicts an illustrative flowchart for providing energy management 500, according to an exemplary embodiment of the invention. The exemplary method 500 is provided by way of example, as there are a variety of ways to carry out methods disclosed herein. The method 500 shown in FIG. 5 may be executed or otherwise performed by one or a combination of various systems. The method 500 is described below as carried out by at least system 200 in FIG. 2 and system 300 in FIG. 3, by way of example, and various elements of systems 200 and 300 are referenced in explaining the exemplary method of FIG. 5. Each block shown in FIG. 5 represents one or more processes, methods, or subroutines carried in the exemplary method 500. A computer readable medium comprising code to perform the acts of the method 500 may also be provided. Referring to FIG. 5, the exemplary method 500 may begin at block 510.

At block 510, the master control unit 206 may determine initial demand targets and tolerances for power. In some embodiments, initial demand targets and tolerances may be input by customer or user based on known information of energy use at a site. In other embodiments, initial demand targets and tolerances may be determined based on information received by one or more network elements 204 connected to equipment 202 at a site. The site may be a residential structure, commercial structure, utility services establishment, government structure, or other structure or entity where efficient power management may be provided.

At block 520, the master control unit 206 may monitor power usage at equipment 202 via one or more network elements 204 communicatively coupled to the equipment 202 at the site. Communication between the master control unit 206 and the one or more network elements 204 may be established through any form of wired or wireless communication, e.g., as described above. Power usage may be monitored by automatic and/or continuous scans. For example, the master control unit 206 may scan input power requests of the equipment 202 via the one or more network elements 204 in predetermined intervals, e.g., every 50 milliseconds. In some embodiments, the master control unit 206 may immediately use information received from the one or more network elements 204. In other embodiments, the information may be stored in one or more data storage units. For example, information may be transmitted to data storage communicatively coupled to the server 214 for retrievability by other components of system 200.

At block 530, the processor module 306 of the master control unit 206 may process the information associated with power usage from the equipment 202. The information may be used to determine efficient management of equipment and to optimize energy consumption to meet the initial demand targets and tolerances.

In some embodiments, efficient management of power usage may include activating and/or deactivating equipment 202 at intervals to reduce peak demand without causing substantial environmental changes at the site. In other embodiments, efficient management of power usage may include load balancing equipment usage based on information from monitoring. For example, power usage patterns and trends may be determined based on information received at the one or more network elements 204. These patterns and trends may be useful in establishing a power schedule for efficiently managing operation and/or limitation of equipment usage at the site.

It should be appreciated that information received from monitoring the equipment using the one or more network elements 204 may also be used to continuously reset and determine optimum demand targets and/or tolerances of the system 200. In some embodiments, the SRCA may use monitoring information and reset demand targets and tolerances to levels that improve power usage efficiency, and thereby reducing peak demand.

At block 540, the master control unit 206 may transmit control data to the one or more network elements 204 to control power usage to equipment at the site. In some embodiments, the control data may be data to activate/deactivate equipment operation. In other embodiments, the control data may be a more complex set of instructions to limit or enhance equipment operation and power usage.

It should be appreciated that while the functions and features of the master control unit 206 are described as being automatic and continuous, other implementations may also be provided. For example, in some embodiments, the master control unit 206 may be manually operated or may be automatic with capability of administrator override. In other embodiments, the features and actions of the master control unit 206 may not be continuous but active only as designated by an administrator locally or remotely. Other various embodiments and implementations to optimize power management may also be provided.

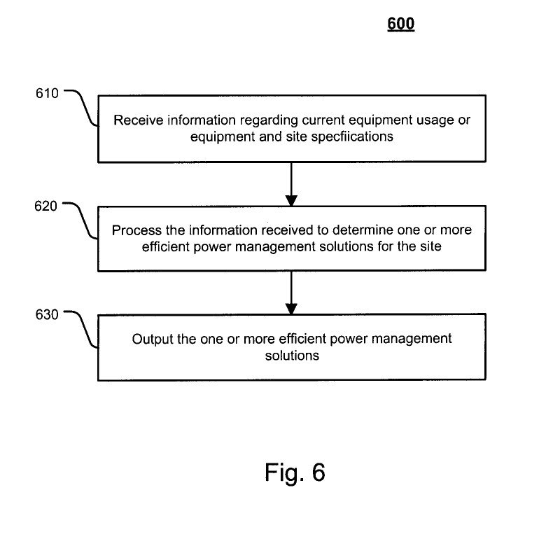

FIG. 6 depicts an illustrative flowchart for providing energy management, according to an exemplary embodiment of the invention. The exemplary method 600 is provided by way of example, as there are a variety of ways to carry out methods disclosed herein. The method 600 shown in FIG. 6 may be executed or otherwise performed by one or a combination of various systems. The method 600 is described below as carried out by at least system 200 in FIG. 2 and system 400 in FIG. 4, by way of example, and various elements of systems 200 and 400 are referenced in explaining the exemplary method of FIG. 6. Each block shown in FIG. 6 represents one or more processes, methods, or subroutines carried in the exemplary method 600. A computer readable medium comprising code to perform the acts of the method 600 may also be provided. Referring to FIG. 6, the exemplary method 600 may begin at block 610.

At block 610, the analyzer 218 may receive information regarding current equipment power usage and/or other power and systems related information. Information associated with current equipment and site specifications may also be received.

At block 620, the processor 406 at the analyzer 218 may use and process this information regarding current equipment power usage to determine one or more efficient power management solutions. The one or more efficient power management solutions may include information associated with cost of implementation, peak demand estimates, cost savings, efficiency cycles, equipment power usage schedules, and/or other related information.

At block 630, the analyzer 218 may output the one or more efficient power management approach/solution. For example, the analyzer may generate one or more reports detailing the one or more efficient power management solutions. The one or more reports may be generated as hardcopies or softcopies usable/importable in a variety formats and protocols, such as document, spreadsheet, and/or database formats.

It should be appreciated that embodiments of the present disclosure may be electronic-based and/or web-based. For example, a centralized server may be provided to coordinate method 500 of FIG. 5 and method 600 of FIG. 6.

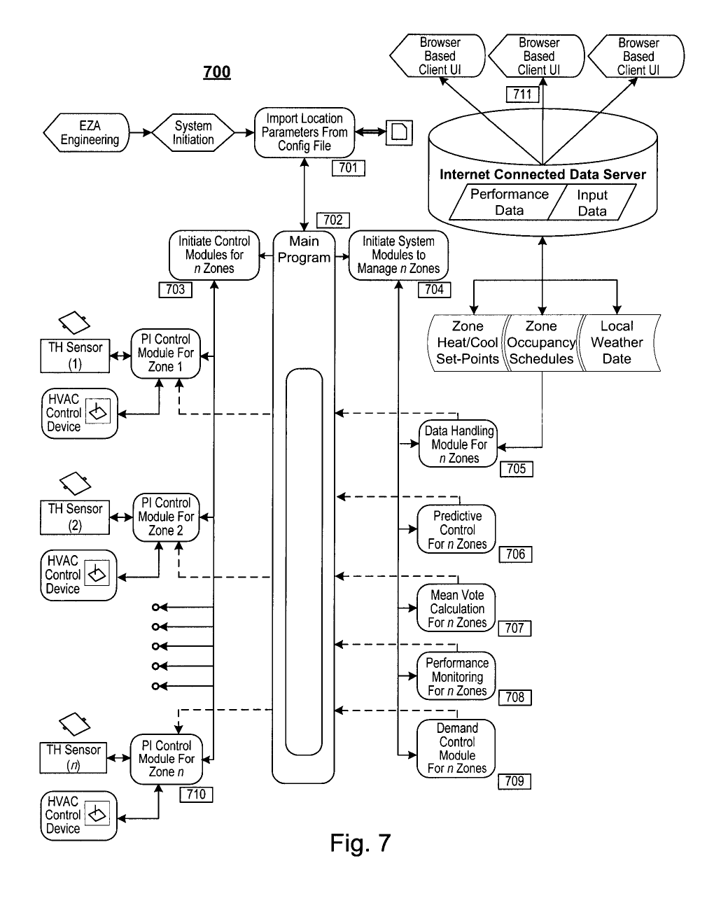

FIG. 7 depicts an illustrative flow for providing energy management 700, according to another exemplary embodiment of the invention. As discussed above, system 200 may be deployed in a unique fashion where the same processing logic is installed in every master control unit 206 during assembly. The processing logic may have the ability to itself create an operating program that is customized to location specific requirements.

After installation an engineer or other similar agent may upload a location specific configuration file and initiate a master control program. This master control program may process the configuration file and create a multi-thread operating program by referring to an onboard library of software modules.

The master control unit 206 may establish supervisory control over all of the network elements 204 in a range 1-n (where n≦256 and where the value of n is specified by the configuration file) and also optimize the performance of each of the n network elements 204 installed. It should be appreciated that n may be >256 in the event more than one master control unit 206 is utilized. The optimized performance of each network element 204 may be achieved by creating an operating program that is made up of at least two types of program threads, such as System Level threads and Zone Level thread.

For Zone Level threads, the master control program may initiate individual Zone Level control scripts for each of the n zones. In some embodiments, these scripts may all function in the same way. They may poll current temperature and humidity data from the relevant sensors communicatively coupled to the network elements 104 and compare this data with the relevant set-point target values and stored historical performance data that are passed into the Zone Level script by the master control program. Based on a standard control theory, control decisions may be made and these are communicated to the network elements 204 (e.g., zone controllers).

System Level threads may be a collection of supervisory management scripts initiated by the master control program. Each of the System Level scripts may have only one instance but passes data to and takes feedback from each of the zone level scripts in the range 1-n.

Referring back to flow 700 of FIG. 7, control and function of processing and control concepts of the system 200 may be described in more detail.

At block 701, system deployment may be provided simply and efficiently. As mentioned above, the fact that equipment 102 (e.g., HVAC) are typically connected to using a standard wiring technique and the fact that the system and methods described above are consistent across most equipment manufacturers allows agents and technicians to quickly install and test the network element 204 and master control unit 206 hardware at any given location.

Once installed, the master control unit 206 may initiate a test procedure to check network connectivity or other connection. When a network connection has been established (e.g., through an onboard GPRS modem) the master control unit 206 may send a request to the application server or database asking for the configuration file for the installed location. Once the configuration file has been received, the master control unit 206 may create Zigbee wireless connections to the one or more network elements 204 (e.g., zone controllers) and the one or more sensors at that location.

As soon as the Zigbee network connections are confirmed as functional, the master control unit 206 may operate its main control scripts and start to create a location specific control program that is based on parameters that have been received in the configuration file.

At block 702, main program initiation and location data discovery may take place. After the system has been successfully installed and the local Zigbee wireless network is operational, the master control unit 206 may configure itself for operation. First, the master control unit 206 may search once more to the configuration file for location specific parameters. At this point, the master control unit 206 may determine the number of zones needed to be created and corresponding control codes may be generated. Once these values are parsed from the configuration file to the master control unit 206, the master control unit 206 may connect to the web server 214 and update the control parameters for the location in question. These parameters may include, but are not limited to, schedule times, set-point targets for different ranges of time and current location specific weather data. These parameters may be stored in onboard RAM for future reference or other storage areas within system 200.

Based on the number of zones being n (where n may be in the range 1-255), the master control unit 206 may then create n Zone Level control sequences for the n network elements 204 and/or sensors that have been installed. The master control unit 206 may also create System Level scripts to manage the n zones.

At block 703, Zone Level control may be initiated. For each zone in the list of zones 1-n the master control unit 206 may set in motion a control thread that functions to control each network element 204 based on standard PI control methods around a set-point. Set-points may be created within the scheduling environment for different periods of time. Both heating and cooling set-points may be set for any period of time through a standard 7-Day/24-hour time span. It should be appreciated that these set-points may be, in some embodiments, automatically transferred to the master control unit 206 if changed within the scheduling environment and are also checked for accuracy by the master control unit 206 every 15 minutes or other predetermined time period. It should be appreciated that schedule and set-point information may stored as a calendar onboard the master control unit 206 and the control script for each zone controller may automatically update to ensure the set-point for the current time period is being used for control purposes.

As the Zone Level script initiation process occurs for each zone controller installed, another single script may be activated which polls each of the n sensors installed. This script may pass the appropriate temperature and humidity data (or other data) for a zone into the PI control script for that zone. The methods used within the PI control script are discussed in more detail in with regard to block 110 of this flow.

At block 704, System Level Control may be initiated. As described above, the master control program may initiate a number of System Level Control scripts. These scripts may function to either pass data to or retrieve data from the Zone Level control scripts. These system level scripts may be run continuously and, if required, may supply an output for each zone in the list of zones 1-n. The output value from a System Level script may be either be a single control decision, which is passed to the relevant Zone Control instance, or may be a factorial value, which is applied to the relevant set-point before it is passed to the relevant Zone Level control instance. These are described in more detail in blocks 105, 106, 107, 108, and 109 referring to primary System Level control scripts.

At block 705, a data handling module may run constantly after initiation. For each of the n zones, the data handling module may forward data to the internet based application server and manage incoming data and requests from the server. The data handling module may ensure that all of the zone specific data is up-to-date and passes to the Zone Level control script if any changes occur.

The data handling module may also manage generation of log files, which document system values, such as zone temperature values, zone humidity values, operating times and system performance values, etc. These log files may be uploaded to the application server every 15 minutes or other predetermined interval. The log files may also be parsed into the application database for use in the monitoring system 108 or remote monitoring system 116.

The data handling module may also function to collate information on any alert conditions that are generated by other scripts. It creates specific alert codes for each type of fault that is encountered and forwards all alert codes to the server where an appropriate alert message is generated for engineering and/or client.

At block 706, a predictive control module may function to ensure that zone conditions reach set-point targets at exactly the required time. Unlike other control solutions where the controller starts to respond to a change in set-point at the exact time that set-point becomes active, the system 200 may work to gradually approach the set-point in as short a period of time possible before the set-point target is required.

For example, a restaurant (e.g., Company) may open for diners at 10 AM. Standard control solutions would require cooling or heating to be set on well before 10 AM so that zone conditions are comfortable by 10 AM. By contrast, system 200 may actually look towards the 10 AM deadline for many hours in advance of that time and based on a number of factors, the system may ensure that the target set-point is reached at exactly the time required with the shortest possible operating time. Some of the factors used to make this determination may include the difference between internal and external temperature, the typical operating ability of the relevant HVAC unit, the current and integral values for the difference between the internal temperature, and the set-point and the time remaining before the set-point change. Other various factors may also be considered.

This feature may be useful for other various scenarios. For example, at closing time, a variation of this method is used to ramp temperature down in advance of the building becoming unoccupied.

As mentioned above the ability to raise and reduce set-point values automatically allows the system to optimize energy savings. While estimates and calculations vary it is broadly agreed across the building science industry that raising set-points while cooling and lowering set-points while heating results in significant savings—even when the adjustment is as little as 1 degree F.

At block 707, a Mean Vote Set-Point Calculation module may be used to evaluate a large number of environmental conditions other than temperature and to make a control decision around temperature combined with these conditions instead of the traditional method of controlling by temperature level only. This combination of environmental conditions and temperature for control purposes may be based on achieving a target thermal comfort level rather than temperature level.

The Mean Vote Calculation module may be designed to create thermal comfort as outlined in ASHRAE Standard 55, Thermal Environmental Conditions for Human Occupancy. Other thermal comfort standards may also be provided.

The thermal comfort target may be established by taking the original set-point for the zone and applying a mean vote factor to it. This factor may be 1 in which case the original set-point is used, however, depending on the conditions taken into consideration, the factor maybe higher than 1 while cooling or lower while heating and a saving can be made by targeting a set-point that is easier to achieve.

The Mean Vote factor may be established by consulting tables of variables and by using formulae logic that produce factors based on relationships between conditions. Some of the conditions taken into consideration may include internal humidity, radiance of heat through windows, position of the sun in the sky in relation to the latitude and longitude of the building, typical clothing level based on time of day, typical clothing level based on time of year, and the differential between external and internal conditions. Other factors may also be provided.

Each of these conditions may contribute an adjustment factor to the Mean Vote Calculation. The calculation may then determine the total adjustment to be applied based on the combination of adjustment factors introduced and apply one final factor to the set-point for the zone. This factorized set-point value may then be passed to the Zone Level control script to be processed.

Ultimately, zone environmental conditions may act to regulate themselves as the Mean Vote Calculation may continuously derive marginal error values from the zone data and adjust to accommodate these errors. It should be appreciated that an instance of the Mean Vote Calculation script may be run for each of the zones on range 1-n.

At block 708, the main control program may initiate a Performance Monitoring module, which takes each of the zones in range 1-n into consideration. The Performance Monitoring module may evaluate the ability of each zone's HVAC equipment. The Performance Monitoring module may monitor the rate of change for temperature and humidity while the unit operates in all stages of control (heating and cooling first and second stages) and compare these to the rate of change of external temperature and humidity for the same period.

The Performance Monitoring module may use an on-board formula to rate the zone's HVAC unit's performance and ability by control stage. This rating may allow a control factor to be issued to the Mean Vote calculation script that helps regulate the set-point target for the individual zone so that the target is optimized to get the best performance from the unit. Such an adjustment may reduce or even eradicate problems such as “set-point hunting” that are common causes of energy waste where the building's HVAC system design is poor and HVAC units are poorly sized for load.

The performance monitoring rating may also allows the system 200 to generate alert messages for service people when units begin performing erratically or below expectations. The module may also act to gather information relating to how the system is performing and may use an array of formula logic to compare what is happening within the system to what would have happened had the system not been installed. These comparison may be used to generate savings values and performance ratings for each system.

At block 709, a Demand Control module may be used by the main program when the level of KW demand in the building exceeds a low-end threshold. The Demand Control module may initiate a process of duty cycling the control of heating and cooling loads so that a high-end demand threshold is not surpassed.

Overall system demand may be determined and monitored by the main program. The main program may use a fixed value in watt-hours (supplied by the local power utility) for each pulse it receives from the Utility Meter Pulse Output card. The quantity of pulses may then be evaluated over time to establish the rate of power use (KW Demand) being used. The low-end demand threshold may be entered to the system through the configuration file at start-up. The Performance Monitoring module may maintain an up-to-date record of the KW load value for each stage of heating and cooling for each zone in the range 1-n. Once initiated, the Demand Control Module may create a priority listing for each of the stages of heating or cooling as required for each of the zones. The priority listing may prioritize unit stages based on the performance rating for that unit created by the Performance Monitoring module. The Demand Control module may forward a control decision to each operating stage of cooling or heating that is generated by comparing the zone stages KW load value with the difference between current demand and the high-end demand threshold. Other various elements, such as the zone stage's position in the priority list, may also be taken into consideration.

Zone-stages with a higher priority number may be more challenged and therefore may be unable to accommodate duty cycling for as long as less challenged units with lower priority numbers. As a result, the Demand Control module may duty-cycle lower priority loads for longer intervals than the high priority loads. Because the process is constantly iterative, the Demand Control module may easily determine whether a unit has become challenged as a result of excessive duty-cycling because its priority number will increase. In this event, the next iteration duty cycles the newly challenged unit for a shorter period of time. The advantage of this Demand Control process is that it constantly derives feedback relating to the impact on operating performance and zone environmental condition and refines its operating procedures to ensure minimum impact as a result of controlling demand.

In extreme conditions, in the event the Demand Control module is unable to maintain a level of comfort within a space and is unable to adjust duty-cycle times any further, the Demand Control module may have the ability to raise its high-end demand threshold to recover the comfort level. Conversely, in the event the Demand Control process finds that it is consistently performing well within the bounds of its high-end demand threshold, the Demand Control module may act to reduce that threshold to the lowest possible level. This ensures that the lowest KW Demand is achieved at all times.

At block 710, the Zone Level Control modules may use a Proportional Integral (PI) control method to be more responsive and energy efficient than using standard “Two-Step” control methods that use hysteresis values and dead-bands for set-point control, which may typically lead to target overshoots, delayed reaction and increased energy consumption. When using a PI controller, the control value is calculated from both a proportional value and an integral proportion. Parameters such as the temperature difference between the actual value and the set-point, the proportional range and the readjustment ability and time are material to the calculation of the control value.

Using this method the controller may correct the space temperature in a quick and reliable manner. The control value may be issued from the PI control loop as a byte control value with a variable range from 0-255 (0-100%). Because the system 200 continues to interact with discrete control inputs, the module converts the analog value into a pulse-width modulation (PWM). Within a constant, defined cycle time, the control output may be set to “on” (or “1”) and then set to “off” again (or “0”) for the calculated percentage period. For example, when a control value of 128 (50%) is calculated for a cycle time of 12 minutes, a “1” instruction may switch the control output on at the beginning of the cycle time, and a “0” instruction may switch the control output off after six minutes. (50% of 12 minutes). When the set-point temperature changes, the controller may recalculate the required control value and reissue the value within the current cycle time.

At block 711, the web server 214 may be accessible via network 110. A user may access to the web server 214 using a Username and Password from any web browser, e.g., at the control stations 112 or remote monitoring station 216. Here, a user may access performance data of the system 200.

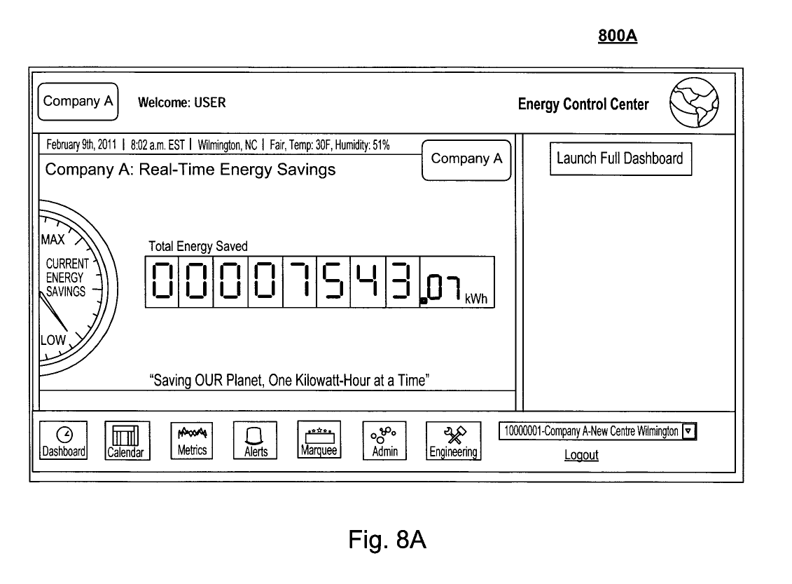

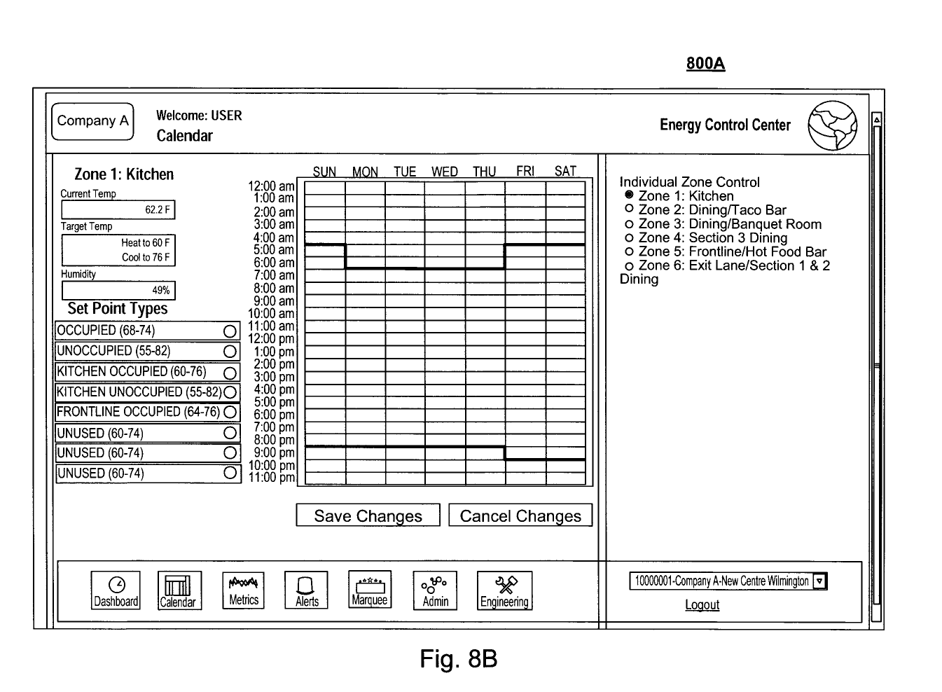

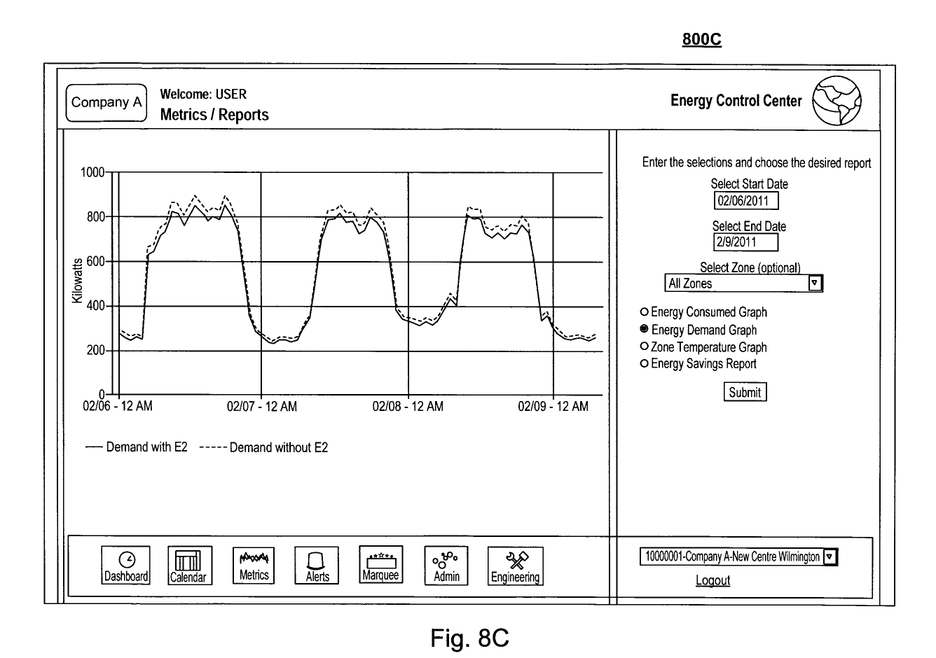

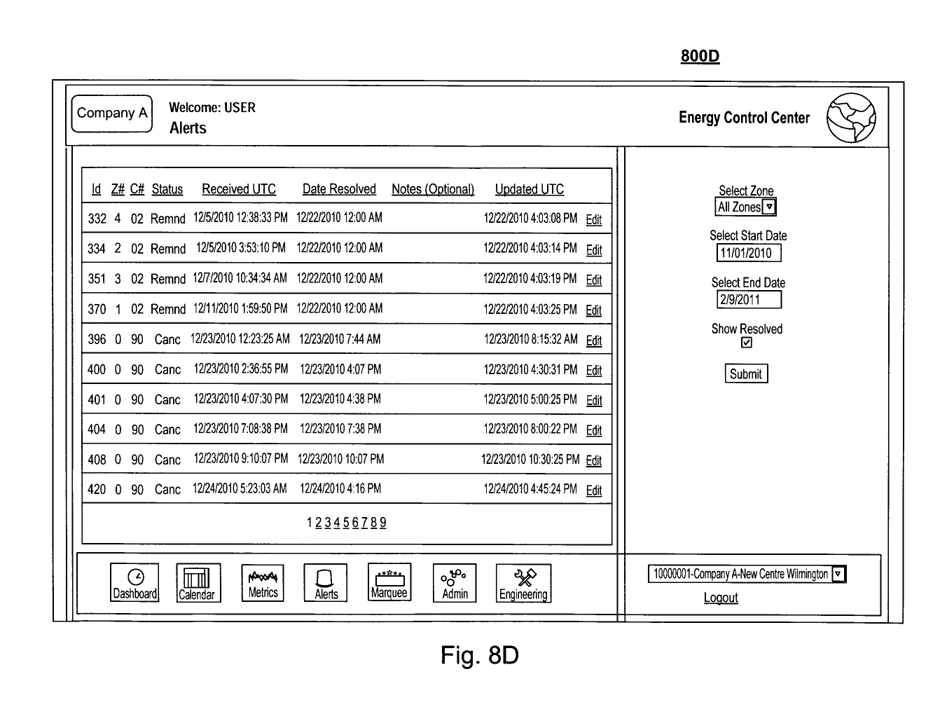

FIG. 8A-8D depict illustrative screens for providing energy information to a user, according to an exemplary embodiment of the invention. The screens may be interactive and user access rights matrix exists so that users may access various levels of control and monitoring function at single or multiple locations.

FIG. 8A depicts an illustrative screen that shows total real-time energy savings values. Other environmental impact equivalences may also be presented. FIG. 8B depicts an illustrative screen that shows a calendar view where users may create Set-Point Schemes which can be applied to different zones and periods of time. FIG. 8C depicts an illustrative screen that shows metrics and other reporting data, such as system performance measures, zone temperatures and savings calculations. FIG. 8D depicts an illustrative screen that shows alerts.

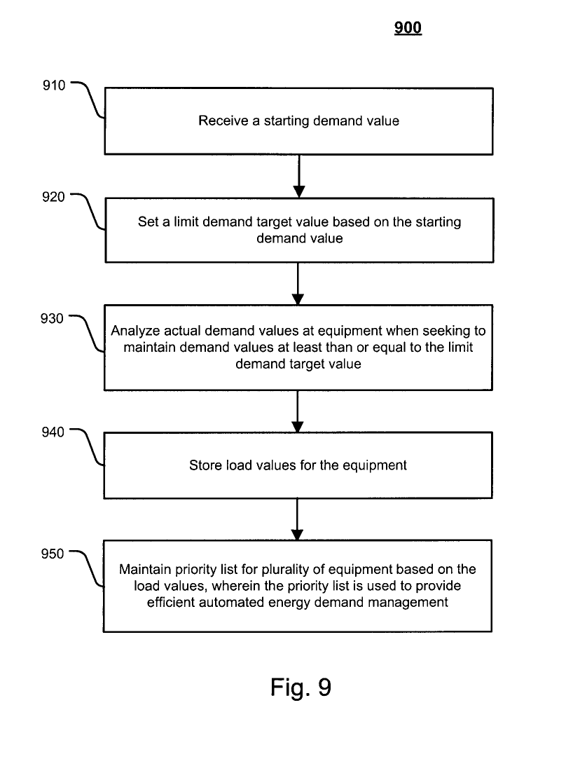

FIG. 9 depicts an illustrative flowchart for providing automated energy demand management at a site 900, according to an exemplary embodiment of the invention. The exemplary method 900 is provided by way of example, as there are a variety of ways to carry out methods disclosed herein. The method 900 shown in FIG. 9 may be executed or otherwise performed by one or a combination of various systems. The method 900 is described below as carried out by at least system 200 in FIG. 2 and system 300 in FIG. 3, by way of example, and various elements of systems 200 and 300 are referenced in explaining the exemplary method of FIG. 9. Each block shown in FIG. 9 represents one or more processes, methods, or subroutines carried in the exemplary method 900. A computer readable medium comprising code to perform the acts of the method 900 may also be provided. Referring to FIG. 9, the exemplary method 900 may begin at block 910.

At block 910, the master control unit 206 may receive a starting demand value. In some embodiments, the starting demand value may be received from a configuration file or manual input. Other various ways to receive the starting demand value may also be provided.

At block 920, the master control unit 206 may set a limit demand target value based on the starting demand value. In some embodiments, the limit demand target value may be less than the starting demand value. For example, the limit demand target value may be set 10% or other percentage lower than the starting demand value.

At block 930, the master control unit 206 may set analyze actual demand values at a plurality of equipment at a site based on operating a master control unit that seeks to maintain demand values at less than or equal to the limit demand target value. In some embodiments, analyzing actual demand values may comprise cycling on and off each of the plurality of equipment in a structured manner in the event the actual demand approaches the limit demand target value. Here, a priority value may be assigned to each of the plurality of equipment based on ability to reach and perform at the limit demand target value. A lower priority may be assigned to equipment that more easily reach and perform at the limit demand target value and a higher priority may be assigned to equipment that have more difficulty in reaching and performing at the limit demand target value.

At block 940, the master control unit 206 may store, in one or more data storage units, load values for each of a plurality of equipment communicatively coupled to the master control unit.

At block 950, the master control unit 206 may maintain a priority list for the plurality of equipment based on the load values. In some embodiments, the priority list may be used to provide efficient automated energy demand management at a site.

It should be appreciated that the master control unit 206 may further activate a demand control system in the event demand at the site reaches a low-level threshold. The master control unit 206 may also cycling on and off each of the plurality of equipment based on assigned priority on the priority list. In some embodiments, each of the plurality of equipment may be cycled for periods of time proportionate to its assigned priority. For example, lower priority equipment may be cycled for longer periods of time and higher priority equipment may be cycled for shorter periods of time to ensure efficient energy demand management at the site. The In some embodiments, the master control unit 206 may also automatically adjust cycling of the plurality of equipment based on changes in the priority list and changes in performance of each of the plurality of equipment.

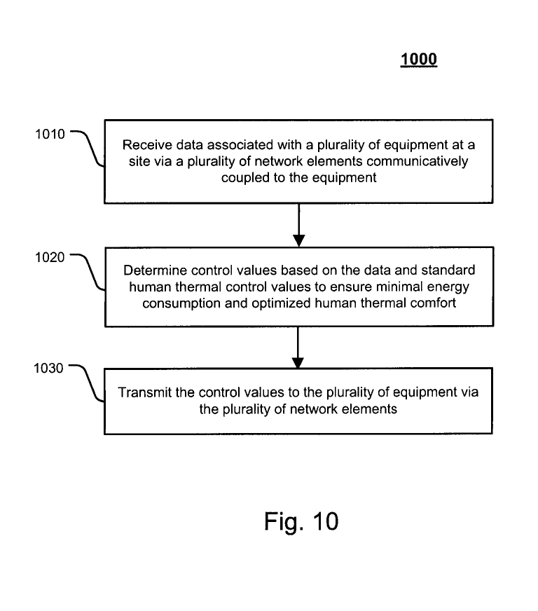

FIG. 10 depicts an illustrative flowchart for reducing energy consumption at a site 1000, according to an exemplary embodiment of the invention. The exemplary method 1000 is provided by way of example, as there are a variety of ways to carry out methods disclosed herein. The method 1000 shown in FIG. 10 may be executed or otherwise performed by one or a combination of various systems. The method 1100 is described below as carried out by at least system 200 in FIG. 2 and system 300 in FIG. 3, by way of example, and various elements of systems 200 and 300 are referenced in explaining the exemplary method of FIG. 10. Each block shown in FIG. 10 represents one or more processes, methods, or subroutines carried in the exemplary method 1000. A computer readable medium comprising code to perform the acts of the method 1000 may also be provided. Referring to FIG. 10, the exemplary method 1000 may begin at block 1010.

At block 1010, the master control unit 206 may receive data associated with a plurality of equipment at a site via a plurality of network elements communicatively coupled to the plurality of equipment.

At block 1020, the master control unit 206 may determine control values based on the data and standard human thermal comfort values to ensure minimal energy consumption and optimized human thermal comfort level at the site. Determining the control values may further comprise processing data of each of the plurality of equipment in relation to each of the other plurality of equipment at the site.

At block 1030, the master control unit 206 may transmit the control values to the plurality of equipment via the plurality of network elements. In some embodiments, the control values may be transmitted at a scheduled time determined by automatically adjusting a schedule configured to minimize equipment operation during a scheduled time period. In other embodiments, the control values may be transmitted in advance of the scheduled time by determining the shortest amount of time required to reach the control target to ensure minimal energy consumption and optimized human thermal comfort level at the start of the scheduled time

It should be appreciated that the master control unit 206 may also transmit an alert notification in the event any equipment begins to perform out of the determined control values. Other various embodiments may also be provided and realized.

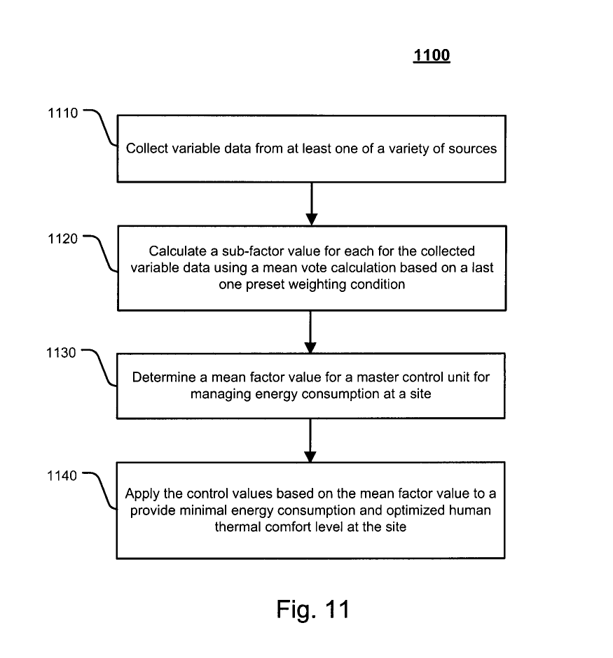

FIG. 11 depicts an illustrative flowchart for determining control values for reducing energy consumption at a site 1100, according to an exemplary embodiment of the invention. The exemplary method 1100 is provided by way of example, as there are a variety of ways to carry out methods disclosed herein. The method 1100 shown in FIG. 11 may be executed or otherwise performed by one or a combination of various systems. The method 1100 is described below as carried out by at least system 200 in FIG. 2 and system 300 in FIG. 3, by way of example, and various elements of systems 200 and 300 are referenced in explaining the exemplary method of FIG. 11. Each block shown in FIG. 11 represents one or more processes, methods, or subroutines carried in the exemplary method 1100. A computer readable medium comprising code to perform the acts of the method 1100 may also be provided. Referring to FIG. 11, the exemplary method 1100 may begin at block 1110.

At block 1110, the master control unit 206 may collect variable data from at least one of a variety of sources. In some embodiments, the variable data may comprise at least one of local internal data, local external data, equipment performance data, time and date data, geographical and site data, and customizable data. The local internal data may comprise internal space target value, internal space temperature data, internal space relative humidity data, internal space carbon dioxide level, and internal occupancy calendar data. The local external data may comprise external temperature data, external humidity data, external barometric data, and external weather data. The geographical and site data may comprise site latitude and longitude, site topographical data, and wall-to-window ratio. The customizable data may comprise clothing level index data and activity level index data. The variety of source may comprise a scheduling server, a zone sensor, a data storage communicatively coupled to a processor of a master control unit at the site, a weather-based server, a configuration file, a location source, and a manual data source. Other various variable data and sources may also be provided.

At block 1120, the master control unit 206 may calculate a sub-factor value for each of the collected variable data using a mean vote calculation based on at least one preset weighting condition. At block 1130, the master control unit 206 may determine a mean factor value for a master control unit configured to control and manage energy consumption communicatively coupled to at least one equipment at a site. At block 1140, the master control unit 206 may apply control values based on the mean factor value to provide minimal energy consumption and optimized human thermal comfort level at the site. It should be appreciated that the master control unit 206 may continuously perform the actions of blocks 1120, 1130, and 1140, e.g., at predetermined intervals, to ensure minimal energy consumption and optimized human thermal comfort level continuously at the site.

It should be appreciated that while the functions and features of the master control unit 206 are described as being automatic and continuous, other implementations may also be provided. For example, in some embodiments, the master control unit 206 may be manually operated or may be automatic with capability of administrator override. In other embodiments, the features and actions of the master control unit 206 may not be continuous but active only as designated by an administrator locally or remotely. Other various embodiments and implementations to optimize power management may also be provided.

In summary, embodiments may provide a system and method for comprehensively and effectively providing power management. It should be appreciated that while embodiments are discussed with respect electrical power and energy management, other types of resources may be managed. These may included water, gas, oil, or other utilities-related resource. It should also be appreciated that although embodiments are described with respect to management of utilities-related resources, the systems and methods discussed above are provided as merely exemplary and may have other various applications and implementations. For example, embodiments may be directed to management of business, production, distribution, or other non-power related enterprises as well.

In the preceding specification, various embodiments have been described with reference to the accompanying drawings. It will, however, be evident that various modifications and changes may be made thereto, and additional embodiments may be implemented, without departing from the broader scope of the disclosure as set forth in the claims that follow. The specification and drawings are accordingly to be regarded in an illustrative rather than restrictive sense.

1. A system for providing automated energy demand management, comprising:
at least one network element communicatively coupled to at least one equipment, wherein the at least one equipment consumes energy or generates energy;
a master control unit communicatively coupled to the at least one network element, wherein the master control unit is configured to monitor and manage energy use at the at least one equipment via the at least one network element; and
a server communicatively coupled to the master control unit over a network, wherein the server is configured to process a variety of information useful for the master control unit.

2. The system of claim 1, wherein the at least one equipment comprises at least one of a thermostat, an HVAC unit, air conditioning unit, a heating unit, a lighting element, an environmental condition sensor, a motorized equipment, and an appliance.

3. The system of claim 1, wherein the at least one network element comprises one or more inputs and outputs and is configured to collect energy data at the at least one equipment.

4. The system of claim 1, wherein the at least one network element communicates with the master control unit using wireless communications comprising at least one of 802.11, RS485, RS232, XBEE radio, Zigbee, 802.15.4, GPRS, and low-rate wireless personal area network (LR-WPAN).

5. The system of claim 1, wherein the master control unit comprises a programmable logic controller, a plurality of communication interfaces, a plurality of equipment interfaces, and one or more data storage units.

6. The system of claim 5, wherein the programmable logic controller is configured to perform the following: load control, load communications, system communications and data-logging, and self-refining control.

7. The system of claim 6, wherein the self-refining control comprises optimizing and managing overall energy demand using at least data collected from the at least one network elements to assess energy demand and create one or more target values for the load control matrix, wherein the load control matrix comprises a cluster of simple functions that operate together with information about the value of load and operating performance at each network element, current consumption and demand data, and predefined targets and tolerances as set by the processor module.

8. The system of claim 1, further comprising one or more sensors communicatively coupled to at least the one or more network elements and the master control unit.

9. The system of claim 8, wherein the one or more sensors comprises at least one of a temperature sensor, a power failure detector, a humidity sensor, and a motion detector.

10. The system of claim 1, further comprising a monitoring system communicatively coupled to the master control unit.

11. The system of claim 10, wherein the monitoring system comprises a meter device for obtain energy consumption readings useful for additional operation and monitoring functions.

12. A system for providing automated energy demand management, comprising:
at least one network element communicatively coupled to at least one equipment and configured to collect energy data at the at least one equipment, wherein the at least one equipment comprises at least one of a thermostat, an HVAC unit, air conditioning unit, a heating unit, a lighting element, an environmental condition sensor, a motorized equipment, and an appliance;
a master control unit communicatively coupled to the at least one network element, wherein the master control unit comprises a programmable logic controller, a plurality of communication interfaces, a plurality of equipment interfaces, and one or more data storage units, and is configured to monitor and manage energy use at the at least one equipment via the at least one network element, wherein the programmable logic controller is configured to perform at least one of the following: load control, load communications, system communications and data-logging, and self-refining control;
one or more sensors communicatively coupled to at least the one or more network elements and the master control unit, wherein the one or more sensors comprises at least one of a temperature sensor, a power failure detector, a humidity sensor, and a motion detector.
a server communicatively coupled to the master control unit over a network, wherein the server is configured to process a variety of information useful for the master control unit; and
a monitoring system communicatively coupled to the master control unit, wherein the monitoring system comprises a meter device for obtain energy consumption readings useful for additional operation and monitoring functions.

12. A system for providing automated energy demand management, comprising:
a network element interface communicatively coupled to at least one network element, wherein the at least one network element is communicatively coupled to at least one equipment that consumes energy or generates energy;
a data storage interface communicatively coupled to at least one data storage unit;
a network interface communicatively coupled to at least one web server over a network;
at least one processor comprising a programmable logic controller configured to perform at least the following: load control, load communications, system communications and data-logging, and self-refining control.

13. A non-transitory computer-implemented method for providing automated energy demand management at a site, comprising:
determining, at a computer processor, initial demand targets and tolerances;
monitoring power usage at equipment using at least one network element communicatively coupled to the equipment;
processing, using the computer, information from the equipment to determine efficient power management of the equipment; and
transmitting control data to manage power efficiently at the equipment.

14. The method of claim 13, wherein the initial demand targets and tolerances are obtained from at least one of user input of known information at the site and information received from the at least one network element.

15. The method of claim 13, wherein monitoring power usage comprises performing continuous scans using the at least one network at predetermined intervals.

16. The method of claim 13, wherein information collected from the continuous scans are used immediately or stored in at least one data storage unit.

17. The method of claim 13, wherein processing the information comprises performing at least the following: load control, load communications, system communications and data-logging, and self-refining control.

18. A computer readable medium comprising code which when executed causes a computer to perform the method of claim 13.

19. A non-transitory computer-implemented method for providing automated energy demand management at a site, comprising:
receiving, at a computer processor, a starting demand value;
setting, at the computer processor, a limit demand target value based on the starting demand value;
analyzing, at the computer processor, actual demand values at a plurality of equipment at a site based on operating a master control unit that seeks to maintain demand values at less than or equal to the limit demand target value;
storing, in one or more data storage units, load values for each of a plurality of equipment communicatively coupled to the master control unit; and
maintaining, by the computer processor, a priority list for the plurality of equipment based on the load values, wherein the priority list is used to provide efficient automated energy demand management at a site.

20. The method of claim 19, wherein the starting demand value is received from a configuration file or manual input.

21. The method of claim 19, wherein the limit demand target value is less than the starting demand value.

22. The method of claim 19, wherein analyzing actual demand values comprises cycling on and off each of the plurality of equipment in a structured manner in the event the actual demand approaches the limit demand target value.

23. The method of claim 19, wherein a priority value is assigned to each of the plurality of equipment based on ability to reach and perform at the limit demand target value.

24. The method of claim 23, wherein a lower priority is assigned to equipment that more easily reach and perform at the limit demand target value and a higher priority is assigned to equipment that have more difficulty in reaching and performing at the limit demand target value.

25. The method of claim 19, further comprising:
activating, at the master control unit, a demand control system in the event demand at the site reaches a low-level threshold; and
cycling on and off each of the plurality of equipment based on assigned priority on the priority list, wherein each of the plurality of equipment is cycled for periods of time proportionate to its assigned priority.

26. The method of claim 25, wherein lower priority equipment is cycled for longer periods of time and higher priority equipment is cycled for shorter periods of time to ensure efficient energy demand management at the site.

26. The method of claim 19, further comprising:
automatically adjusting cycling of the plurality of equipment based on changes in the priority list and changes in performance of each of the plurality of equipment.

27. A computer readable medium comprising code which when executed causes a computer to perform the method of claim 19.
